(19) United States
(12) Patent Application Publication
(10) Pub. No.: US 2020/0143438 A1
(43) Pub. Date: May 7, 2020

(54) COST MODEL STRUCTURE GENERATION FOR SERVICE OFFERINGS

(71) Applicant: International Business Machines Corporation, Armonk, NY (US)

(72) Inventors: Kugamoorthy Gajananan, Tokyo (JP); Taiga Nakamura, Sunnyvale, CA (US); Aly Megahed, San Jose, CA (US); Shubhi Asthana, Santa Clara, CA (US)

(21) Appl. No.: 16/182,470

(22) Filed: Nov. 6, 2018

(51) Int. Cl. G06Q 30/02

(52) U.S. Cl. CPC G06Q 30/0283; G06Q 30/0206; G06Q 30/0201

(57) ABSTRACT

A computer-implemented method, according to one embodiment, includes: receiving information which corresponds to an offering, and generating an offering definition by defining basic properties of the offering. Defining the basic properties of the offering includes: defining one or more cost drivers which correspond to the offering, and defining one or more cost components which correspond to the offering. The basic properties of the offering are further used to generate one or more cost model output structures. The one or more cost model output structures are also merged with a single cost model, and the single cost model is updated. Other systems, methods, and computer program products are described in additional embodiments.

### BACKGROUND

The present invention relates to service offerings, and more specifically, this invention relates to generating cost model structures for service offerings.

Information technology (IT) service providers compete to secure highly valued IT service contracts. These service contracts typically involve of complex IT services such as cloud computing, UNIX, mainframes, etc. To be competitive, service providers design solutions that fulfil the client's desires. Traditionally, the approach to define such a solution was to establish a laundry list of services that a given customer desires, where each service represents a distinctive element delivering a specific feature and value. A solution was thereby defined as a hierarchy of such distinctive services, as well as the corresponding costs and prices.

Recently, however, an increasing trend for IT services business is to identify and define a solution based on service offerings. A service offering refers to a set of related products and services grouped together as a bundle. IT service providers implement the concept of service bundle to differentiate their solution compared to the ones from competitors or to decrease their costs benefiting from standardization and economies of scale.

IT providers often build service offerings primarily driven by market competitiveness and customer business standards. It is often the case that offerings focus on a specific industry or an application domain. To achieve that, an offering is typically composed of a complex combination of various service elements. This forces the team defining an offering to possess deeper knowledge and expertise in building a given service bundle, e.g., such as technical specifications, architecture, costing and/or pricing, support, delivery, etc. Alternatively, “solutioners” (who are subject matter experts on a certain industry or an application domain) often build service bundles, each of which have a narrow scope within the offering boundary.

In an IT services business scenario, one or more service offerings may be implemented in order to build an integrated solution that meets the client's IT desires. However, for an integrated solution built using multiple offerings, it is significantly challenging for IT providers to come up with a cost model which involves parametric equations and/or formulae used to estimate the costs of a product and/or service element.

### SUMMARY

A computer-implemented method, according to one embodiment, includes: receiving information which corresponds to an offering, and generating an offering definition by defining basic properties of the offering. Defining the basic properties of the offering includes: defining one or more cost drivers which correspond to the offering, and defining one or more cost components which correspond to the offering. The basic properties of the offering are further used to generate one or more cost model output structures. The one or more cost model output structures are also merged with a single cost model, and the single cost model is updated.

A computer program product, according to another embodiment, includes a computer readable storage medium having program instructions embodied therewith. The computer readable storage medium is not a transitory signal per se. Moreover, the program instructions are readable and/or executable by a processor to cause the processor to perform a method which includes: receiving, by the processor, information which corresponds to an offering; and generating, by the processor, an offering definition by defining basic properties of the offering. Defining the basic properties of the offering includes: defining one or more cost drivers which correspond to the offering, and defining one or more cost components which correspond to the offering. The basic properties of the offering are further used, by the processor, to generate one or more cost model output structures. The one or more cost model output structures are also merged, by the processor, with a single cost model; and the single cost model is updated by the processor.

A system, according to yet another embodiment, includes: a processor, and logic integrated with the processor, executable by the processor, or integrated with and executable by the processor. The logic is configured to: receive, by the processor, information which corresponds to an offering; and generate, by the processor, an offering definition by defining basic properties of the offering. Defining the basic properties of the offering includes: defining one or more cost drivers which correspond to the offering, and defining one or more cost components which correspond to the offering. The basic properties of the offering are further used, by the processor, to generate one or more cost model output structures. The one or more cost model output structures are also merged, by the processor, with a single cost model; and the single cost model is updated by the processor.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a network architecture, in accordance with one embodiment.

FIG. 2 is a representative hardware environment that may be associated with the servers and/or clients of FIG. 1, in accordance with one embodiment.

FIG. 3 is a tiered data storage system in accordance with one embodiment.

FIG. 4A is a flowchart of a method in accordance with one embodiment.

FIG. 4B is a flowchart of sub-processes for one of the operations in the method of FIG. 4A, in accordance with one embodiment.

FIG. 4C is a representational view of the cost driver hierarchy for the virtualization offering definition, in accordance with an in-use example.

FIG. 4D is a flowchart of sub-processes for one of the operations in the method of FIG. 4A, in accordance with one embodiment.

FIG. 4E is a representational view of the cost component hierarchy for the virtualization offering definition, in accordance with an in-use example.

FIG. 4F is a representational view of the cost component specification for an offering definition, in accordance with an in-use example.

FIG. 4G is a representational view of the labor service rates section of a cost component, in accordance with an in-use example.

FIG. 4H is a flowchart of sub-processes for one of the operations in the method of FIG. 4A, in accordance with one embodiment.

FIG. 4I is a representational view of an outline structure for a cost model pattern, in accordance with an in-use example.

FIG. 4J is a representational view of the baselines section of a cost model pattern, in accordance with an in-use example.

FIG. 4K is a representational view of the parameter section of a cost model pattern, in accordance with an in-use example.

FIG. 4L is a representational view of the component section of a cost model pattern, in accordance with an in-use example.

FIG. 4M is a partial representational view of a cost model output structure, in accordance with an in-use example.

FIG. 5 is partial representational view of an architecture, in accordance with one embodiment.

FIG. 6 is a representational view of a cost model output structure generation process, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products which provide unified frameworks which allow for a consistent approach in specifying cost models for different service offerings while also maintaining the flexibility to handle any individual differences among them. Moreover, some of the embodiments described below provide a unified framework that is able to generate cost model structures for the service offerings in a coherent and efficient manner. Accordingly, offerings may consistently be defined, thereby introducing the possibility of generating cost models that could be combined into a single cost model which is able to compute an integrated solution of an entire deal, e.g., as will be described in further detail below.

In one general embodiment, a computer-implemented method includes: receiving information which corresponds to an offering, and generating an offering definition by defining basic properties of the offering. Defining the basic properties of the offering includes: defining one or more cost drivers which correspond to the offering, and defining one or more cost components which correspond to the offering. The basic properties of the offering are further used to generate one or more cost model output structures. The one or more cost model output structures are also merged with a single cost model, and the single cost model is updated.

In another general embodiment, a computer program product includes a computer readable storage medium having program instructions embodied therewith. The computer readable storage medium is not a transitory signal per se. Moreover, the program instructions are readable and/or executable by a processor to cause the processor to perform a method which includes: receiving, by the processor, information which corresponds to an offering; and generating, by the processor, an offering definition by defining basic properties of the offering. Defining the basic properties of the offering includes: defining one or more cost drivers which correspond to the offering, and defining one or more cost components which correspond to the offering. The basic properties of the offering are further used, by the processor, to generate one or more cost model output structures. The one or more cost model output structures are also merged, by the processor, with a single cost model; and the single cost model is updated by the processor.

In yet another general embodiment, a system includes: a processor, and logic integrated with the processor, executable by the processor, or integrated with and executable by the processor. The logic is configured to: receive, by the processor, information which corresponds to an offering; and generate, by the processor, an offering definition by defining basic properties of the offering. Defining the basic properties of the offering includes: defining one or more cost drivers which correspond to the offering, and defining one or more cost components which correspond to the offering. The basic properties of the offering are further used, by the processor, to generate one or more cost model output structures. The one or more cost model output structures are also merged, by the processor, with a single cost model; and the single cost model is updated by the processor.

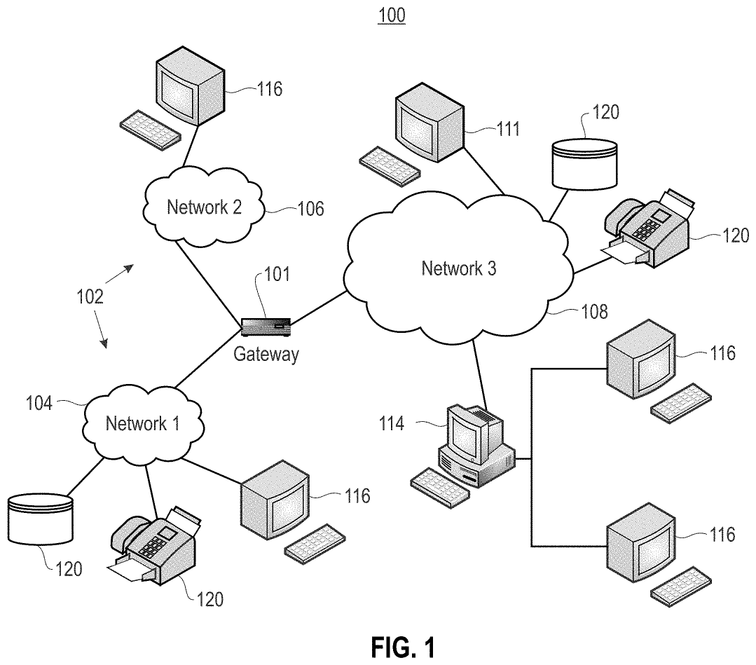

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

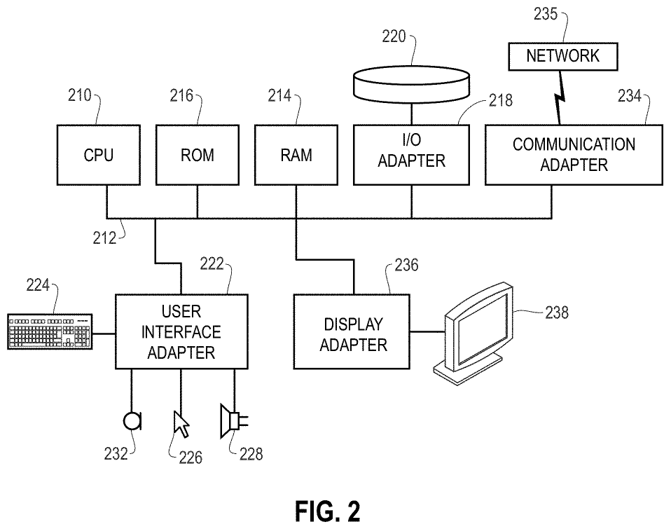

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using eXtensible Markup Language (XML), C, and/or C++ language, or other programming languages, along with an object oriented programming methodology. Object oriented programming (OOP), which has become increasingly used to develop complex applications, may be used.

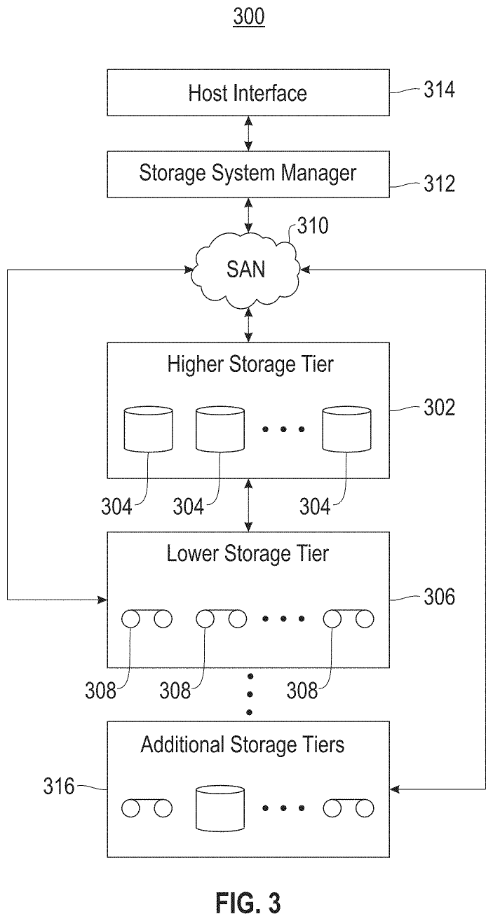

Now referring to FIG. 3, a storage system 300 is shown according to one embodiment. Note that some of the elements shown in FIG. 3 may be implemented as hardware and/or software, according to various embodiments. The storage system 300 may include a storage system manager 312 for communicating with a plurality of media and/or drives on at least one higher storage tier 302 and at least one lower storage tier 306. The higher storage tier(s) 302 preferably may include one or more random access and/or direct access media 304, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 306 may preferably include one or more lower performing storage media 308, including sequential access media such as magnetic tape in tape drives and/or optical media, slower accessing HDDs, slower accessing SSDs, etc., and/or others noted herein or known in the art. One or more additional storage tiers 316 may include any combination of storage memory media as desired by a designer of the system 300. Also, any of the higher storage tiers 302 and/or the lower storage tiers 306 may include some combination of storage devices and/or storage media.

The storage system manager 312 may communicate with the drives and/or storage media 304, 308 on the higher storage tier(s) 302 and lower storage tier(s) 306 through a network 310, such as a storage area network (SAN), as shown in FIG. 3, or some other suitable network type. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 300 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 302, may include a majority of SSD storage media for storing data in a higher performing storage environment, and remaining storage tiers, including lower storage tier 306 and additional storage tiers 316 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the embodiments presented herein.

According to some embodiments, the storage system (such as 300) may include logic configured to receive a request to open a data set, logic configured to determine if the requested data set is stored to a lower storage tier 306 of a tiered data storage system 300 in multiple associated portions, logic configured to move each associated portion of the requested data set to a higher storage tier 302 of the tiered data storage system 300, and logic configured to assemble the requested data set on the higher storage tier 302 of the tiered data storage system 300 from the associated portions.

Of course, this logic may be implemented as a method on any device and/or system or as a computer program product, according to various embodiments.

As previously mentioned, a recent trend in IT service business is to identify and define a solution based on service offerings. A service offering refers to a set of related products and services grouped together as a bundle. IT service providers implement the concept of service bundle to differentiate their solution compared to the ones from competitors or to decrease their costs benefiting from standardization and economies of scale.

IT providers often build service offerings primarily driven by market competitiveness and customer business standards. It is often the case that offerings focus on a specific industry or an application domain. To achieve that, an offering is typically composed of a complex combination of various service elements. This forces the team defining an offering to possess deeper knowledge and expertise in building a given service bundle, e.g., such as technical specifications, architecture, costing and/or pricing, support, delivery, etc. Alternatively, solutioners often build service bundles, each of which have a narrow scope within the offering boundary.

In an IT services business scenario, one or more service offerings may be implemented in order to build an integrated solution that meets the client's IT desires. However, for an integrated solution built using multiple offerings, it is significantly challenging for IT providers to come up with a cost model which involves parametric equations and/or formulae used to estimate the costs of a product and/or service element.

One reason for difficulty is the lack of consistent approaches to developing cost models for individual offerings. An offering team may have their own custom approaches for building cost models for their respective offerings based on their industry or application oriented standards. However, it is preferred that a cost model for an integrated solution take the overlaps, gaps, similarities, differences, etc. of cost models for the multiple offerings which form the solution into consideration. This is especially true when the same service element (e.g. project management) is included in multiple offerings in an integrated solution. In such cases, solutioners should proactively investigate deviations in cost and determine if the cost is appropriate to the service being provided in an offering. If it is not, then they should take appropriate action. If the costs are considered appropriate then an argument for the client is warranted in terms of the additional value being provided that justifies the cost deviation.

Another reason for difficulty in developing a cost model for an integrated solution is that offering teams with the specialized knowledge and expertise in building an application oriented offering may not always use the best practices in place which may lead to inconsistencies. As such, there may often be knowledge and expertise gap among multiple offerings.

Further, when building a cost model for an integrated solution using multiple offerings, solutioners benefit from an understanding of cost models for different offerings such that they may manually combine them into a single cost model, which is a labor-intensive, time-consuming and error-prone process.

Therefore, an efficient and consistent approach to building cost models for different service offerings is desired, particularly in situations which involve building a cost model for an integrated solution which includes multiple bundles. This is particularly true as offering portfolios grow in number and complexity, while the number of skilled resources decreases.

In sharp contrast to the aforementioned conventional shortcomings, various ones of the embodiments included herein provide unified frameworks which allow for a consistent approach in specifying cost models for different service offerings while also maintaining the flexibility to handle any individual differences among them. Moreover, some of the embodiments described below provide a unified framework that is able to generate cost model structures for the service offerings in a coherent and efficient manner. Accordingly, offerings may consistently be defined, thereby introducing the possibility of generating cost models that could be combined into a single cost model which is able to compute an integrated solution of an entire deal, e.g., as will be described in further detail below.

A part of establishing a unified framework involves the introduction of a construct referred to herein as an “offering definition”. An offering definition involves the configuration of services which are ultimately bundled in an offering. In an offering definition, two concepts are typically specified, those being referred to as a “cost driver” and a “cost component”. Cost drivers refer to factors that drive the cost of a service element in an offering, while cost components capture the cost of a service element in the offering. Moreover, cost components are usually specified with some characteristics that state how the cost computation should be customized. Each cost component of an offering definition also preferably has some cost drivers associated with it. This association between the cost components and the cost drivers assists in modeling which factors are influencing the cost computation of a given service element.

The primary construct of generating cost models in some of the approaches herein involves an underlying formula that defines how a cost of a service element in an offering should be computed based on a set of factors. Each of these formulas takes a set of inputs and produces a resultant cost which is based on a number of additional factors included in the formula, e.g., again as will be described in further detail below. Cost drivers correspond to the input of the aforementioned underlying formulas, while cost components often relate to the output of the formulas.

Moreover, to establish a unified and consistent mechanism for cost model specification of different offerings, various ones of the approaches herein define a set of abstract structures of formulae in a “cost model pattern”. Each formula in a given cost model pattern refers to cost computation under different conditions for the same component that corresponds to a given service element. To allow customization of the cost model specifications for different offerings, additional constructs are introduced as part of a pattern, namely parameters. These parameters greatly assist in customizing cost models for different offerings, e.g., as will soon become apparent.

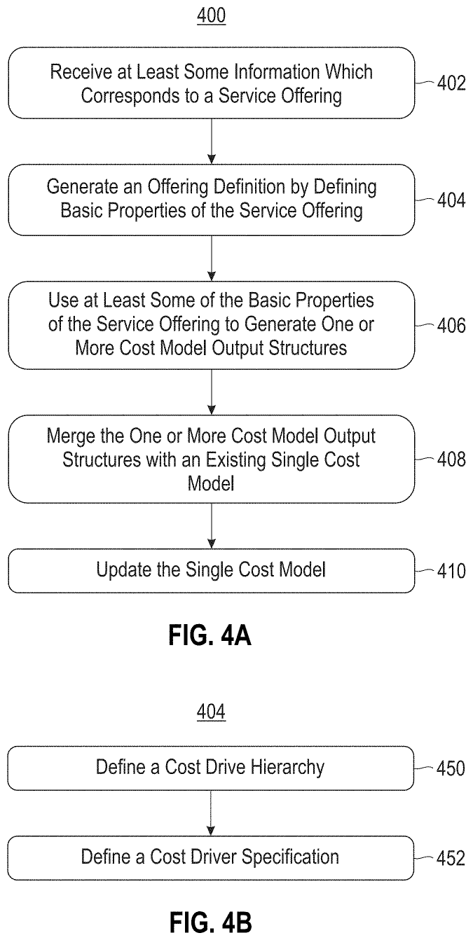

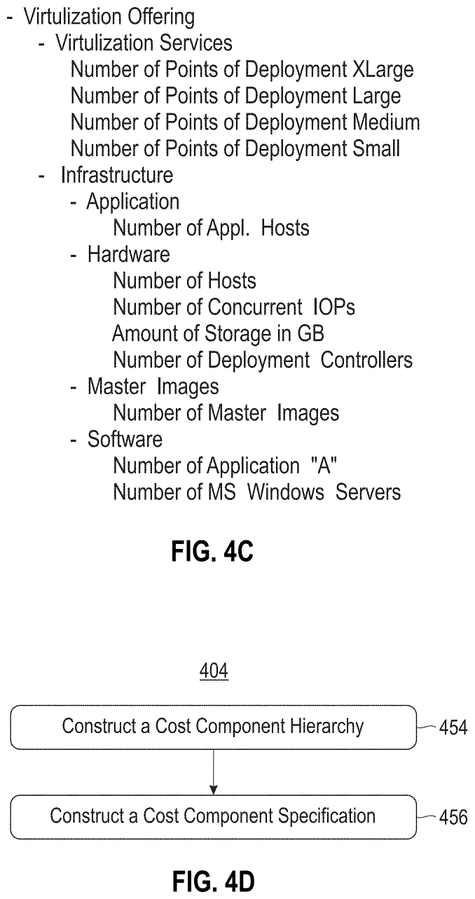

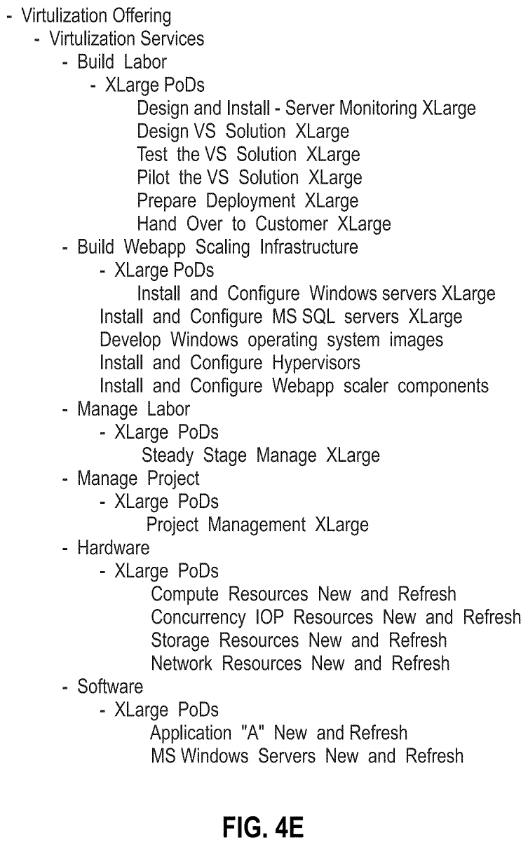

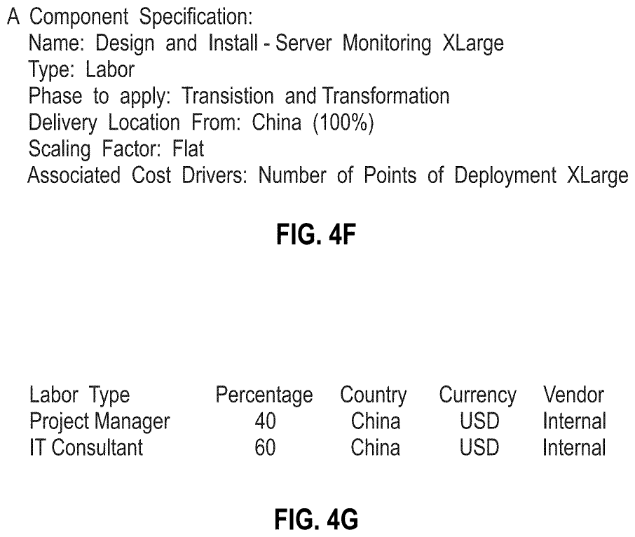

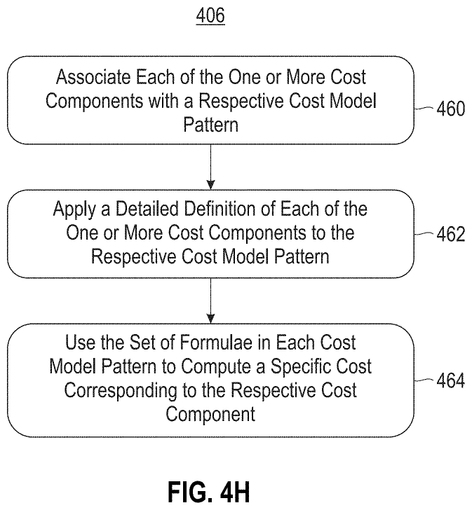

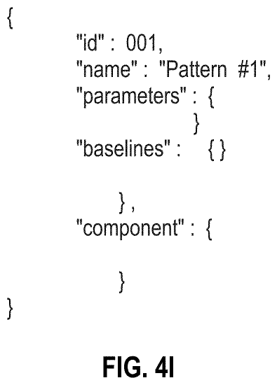

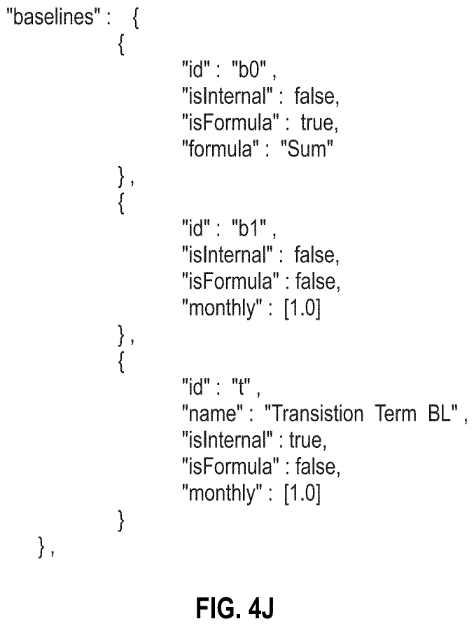

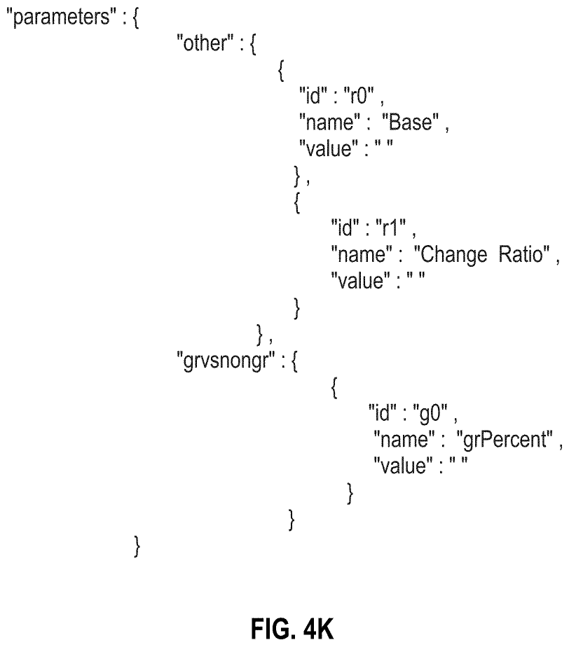

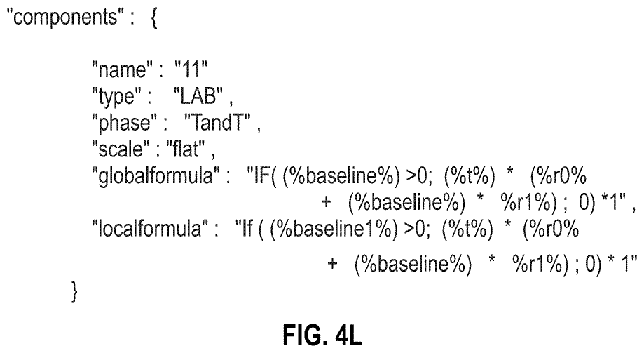

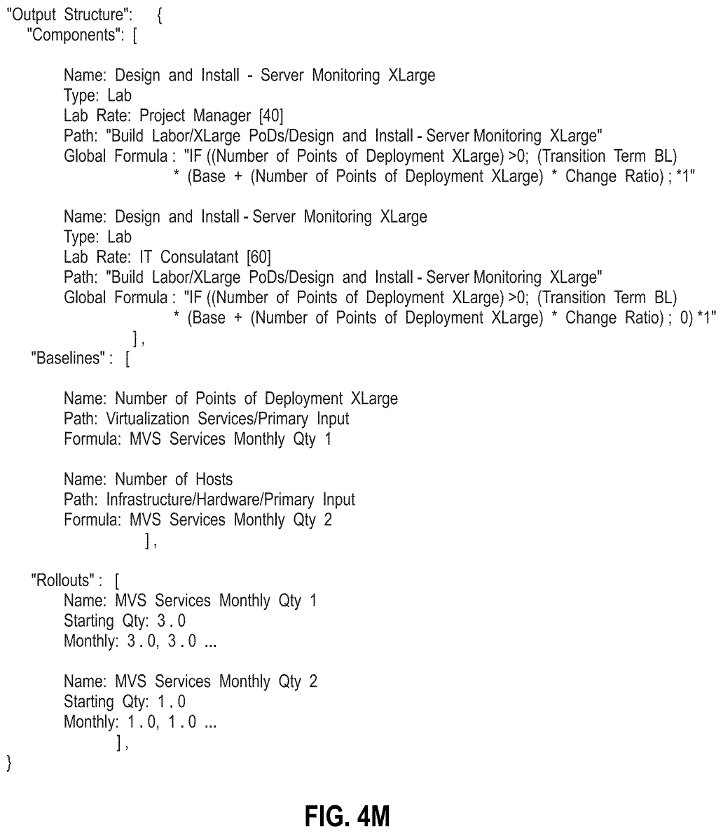

Referring now to FIG. 4A, a flowchart of a method 400 is shown according to one embodiment. The method 400 may be performed in accordance with the present invention in any of the environments depicted in FIGS. 1-3, among others, in various embodiments. Of course, more or less operations than those specifically described in FIG. 4A may be included in method 400, as would be understood by one of skill in the art upon reading the present descriptions.

Each of the steps of the method 400 may be performed by any suitable component of the operating environment. For example, in various embodiments, the method 400 may be partially or entirely performed by a controller, a processor, a computer, etc., or some other device having one or more processors therein. Thus, in some embodiments, method 400 may be a computer-implemented method. Moreover, the terms computer, processor and controller may be used interchangeably with regards to any of the embodiments herein, such components being considered equivalents in the many various permutations of the present invention.

Moreover, for those embodiments having a processor, the processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4A, operation 402 of method 400 includes receiving at least some information which corresponds to a service offering. According to some approaches, the information is received from a potential customer who is interested in a particular service offering. As mentioned above, a service offering refers to a set of related products and services grouped together as a bundle. Thus, the information received in operation 402 typically describes, or at least corresponds to, the type of services and/or products desired by the potential customer.

Moreover, operation 404 includes generating an offering definition by defining basic properties of the service offering. In preferred approaches, the process of defining the basic properties of the service offering includes defining one or more cost drivers which correspond to the service offering, and defining one or more cost components which also correspond to the service offering. As mentioned above, cost drivers refer to factors which drive (e.g., “influence”) the cost of a service element in a given offering, while cost components capture the cost of a service element in the offering. A cost component is also specified with some characteristics which state how the cost computation may be customized, e.g., depending on the given approach. Moreover, it should be appreciated that each cost component of a given offering definition may also have one or more cost drivers associated therewith. As a result, modeling which identifies factors that are influencing the cost consumption of a service element can be achieved. It should also be noted that the number and/or type of cost components that are supported or even implemented in a given embodiment is not fixed, but rather is flexible and may be adjusted over time as service offerings and/or information corresponding thereto is received.

However, the basic properties for an offering definition in some approaches includes an offering name and a delivery location. With respect to the present description, the “delivery location” typically refers to the default country, region, state, etc. where the offering would be delivered. Thus, the delivery location mirrors the potential customer's location in some approaches. It follows that the delivery location for a given offering is a factor that may have an influence on the cost(s) of service offerings, e.g., such as offerings involving labor type services.

The services that are used to form an IT-based offering typically have a hierarchical nature with up to three or four levels. For instance, end users (as a top level service) might have end user emails and/or end user chatting systems as level two subservices. Each of these level two subservices may further have some level three sub-subservices, and so on. Moreover, types of services include labor, hardware, software, etc., or any other types of miscellaneous services which may not fall under any standard service categories. The hierarchical nature of services influences the conceptualization of cost drivers and cost components of an offering definition. More specifically, cost drivers and cost components are specified in a hierarchical format for an offering definition in some approaches maintain consistency with the aforementioned nature of the included services.

These hierarchies are defined in some approaches by using a particular service taxonomy which assists the framework in providing a consistent approach for specifying cost drivers and cost components of an offering definition. As a result, cost models for different service offerings can be specified in a consistent manner while accommodating the flexibility to handle individual differences among them.

Referring momentarily to FIG. 4B, exemplary sub-processes of generating an offering definition by defining basic properties of the service offering are illustrated in accordance with one embodiment, one or more of which may be used to perform operation 404 of FIG. 4A. More specifically, FIG. 4B depicts exemplary sub-processes of defining one or more cost drivers which correspond to the service offering. However, it should be noted that the sub-processes of FIG. 4B are illustrated in accordance with one embodiment which is in no way intended to limit the invention.

As shown, sub-operation 450 of the flowchart includes defining a cost drive hierarchy. While the cost drive hierarchy may be defined differently, e.g., depending on the desired approach, FIG. 4C illustrates a cost driver hierarchy for a virtualization offering definition in accordance with an in-use example, which is in no way intended to limit the invention. For this specific example, the logical grouping of the cost drivers has been specified under two major categories labeled “Virtualization Services” and “Infrastructure”. To assist in describing the relative framework and cost model specification approach, a typical service offering called “virtualization” is implemented from an IT service provider. The virtualization offering is designed to create a consolidated, virtualized end-user desktop solution for a customer. Moreover, this offering is created in some approaches by bundling a set of hardware and software products, and labor services to monitor a virtualized desktop environment. Moreover, these two categories are preferably implemented in order to provide the services, but additional and/or different categories may be included depending on the approach. As shown, the “Virtualization Services” category further includes four cost drivers thereunder, while the “Infrastructure” category further decomposes in to hardware, software, application, master images, etc.

Referring still to FIG. 4C, the leaf nodes of the cost driver listed under the “Virtualization Services” each refer to parts that drive costs of services which are provided in the offering. Moreover, the cost of services driven by a given cost driver is determined by the number of deployment points in the whole solution, e.g., as would be appreciated by one skilled in the art after reading the present description.

In each branch of the tree structure, it is considered that the leaf nodes refer to the actual cost driver factor. Intermediate nodes provide a logical grouping referring to the summation of its child nodes. Thus, in situations where an intermediate cost driver node is associated with a cost component of an offering definition, the formula for computing the cost for the given cost component preferably considers the summation of the child nodes of the associated cost drivers as an input.

Referring back to FIG. 4B, the flowchart further includes defining a cost driver specification. See sub-operation 452. According to some approaches, each cost driver is defined with one or more of an identification (ID), a name, a starting quantity, an optional relative path in the logical hierarchy, etc. Moreover, the ID of a cost driver is internally generated and uniquely identifies each cost driver in preferred approaches.

Looking now to FIG. 4D momentarily, exemplary sub-processes of generating an offering definition by defining basic properties of the service offering are illustrated in accordance with one embodiment, one or more of which may be used to perform operation 404 of FIG. 4A. More specifically, FIG. 4D depicts exemplary sub-processes of defining one or more cost components which correspond to the service offering. However, it should be noted that the sub-processes of FIG. 4D are illustrated in accordance with one embodiment which is in no way intended to limit the invention.

As shown, sub-operation 454 of the flowchart includes constructing a cost component hierarchy. Again, a cost component represents the factors that determine how the cost of a service element in an offering may be computed, along with how the cost should be customized with respect to specific characteristics of the offering. Moreover, similar to cost drivers, cost components of an offering are also preferably structured in a hierarchical manner. The hierarchical structure of a cost component is inspired by its corresponding service hierarchy in some approaches. As a result, logical groupings of similar components are able to be grouped together in an offering definition.

FIG. 4E illustrates a cost component hierarchy for a virtualization offering definition in accordance with an in-use example, which is in no way intended to limit the invention. The cost components for the offering in this example are logically grouped in to the types of services such as labor (e.g., “Build Labor”, “Manage Labor”, etc.), “Hardware”, “Software”, etc. In each branch of the tree, the leaf nodes corresponding to the actual cost of the services delivered in the offering are considered. Moreover, the intermediate nodes provide a logical structure. For instance, in FIG. 4E, the leaf node named “Design and Install—Server Monitoring XLarge” is a cost component, and the intermediate nodes “Build Labor” and “XLarge PoDs” are actually logical groups.

Further, a cost component which will be driven by multiple cost drivers is conceptualized. As a result, more than one cost driver may be associated with the cost component. Yet in other approaches, a cost driver may associate itself with (e.g., influence the cost of) multiple cost components in an offering definition.

Returning to the flowchart of FIG. 4D, sub-operation 456 includes constructing a cost component specification. In other words, each cost component is specified with an ID (which may be internally managed), a name, a type (e.g., such as labor, hardware, software, miscellaneous, etc.), phase to apply, delivery location, scaling factor, a set of associated cost drivers, etc. For instance, FIG. 4E illustrates a specification for a cost component named “Design and Install—Server Monitoring XLarge”. The specification of the cost component includes what type of service it corresponds to (Labor), what phase of service delivery should be considered (Transition and Transformation), the economics of scale to apply (Flat), as well as the associated cost drivers.

Depending on the approach, the phase of service delivery may either be transition and transformation or steady-state. With respect to the present description, “transition and transformation” refers to the time period in which the provider can setup the new services of an offering and move the customers under new services from their current state. Moreover, “steady-state” refers to the ongoing delivery of services provided in an offering. The “delivery location” of a component refers to the country, region, state, etc. from which the corresponding service element would be delivered. In some approaches, the delivery location for individual cost components can be different from the one specified for the entire offering definition. In such approaches, cost computation for individual offerings takes its own delivery location instead of the country specified for the overarching offering definition. A percentage may also be associated with the delivery location in some approaches, the percentage indicating what portion of the service is delivered from the given delivery location.

“Scaling factor” or “financial factor” represents economics of scale, which means that depending on an amount of the overall service that is delivered, the cost of it may change. Scaling factor specification includes additional parameters that may be used to describe how the cost should be adjusted based on the amount of service delivered. In this example, “flat” means cost would not change regardless of the amount of service that is actually delivered. Furthermore, the cost driver “Number of Point of Deployments XLarge” is associated with the cost component “Design and Install—Server Monitoring XLarge” as shown in FIG. 4F.

Further still, in some approaches each cost component in an offering definition includes a construct referred to as a “service rate”. With respect to the present description, a service rate refers to the actual dollar value of the service element represented by the cost component in an offering definition. For instance, if the service element is of labor type (e.g. “Steady stage mange XLarge” in FIG. 4E), then the unit cost for providing the service is to be specified. A service element may involve different types of labor, e.g., such as project manager, IT consultant, analyst, etc. Accordingly, the rate section for a cost component that represents the service element may have multiple service rates specified, each service rate contributing a certain percentage. In some approaches, an IT provider can subcontract a service to another vendor, in which case different service rates would apply for such labor services. FIG. 4G illustrates an illustrative set of labor rates specified for a cost component in accordance with one example, which is in no way intended to limit the invention.

Referring back now to FIG. 4A, method 400 further includes using at least some of the basic properties of the service offering to generate one or more cost model output structures. See operation 406. In preferred approaches, a cost model output structure is generated for each cost component defined in the process of generating the offering definition in operation 404 above. For instance, each of the cost model output structures are generated in some approaches by associating each of the one or more cost components with a respective cost model pattern. Accordingly, referring momentarily to FIG. 4H, exemplary sub-processes of using at least some of the basic properties of the service offering to generate a cost model structure for the offering definition are illustrated in accordance with one embodiment, one or more of which may be used to perform operation 406 of FIG. 4A. However, it should be noted that the sub-processes of FIG. 4H are illustrated in accordance with one embodiment which is in no way intended to limit the invention.

As shown, sub-operation 460 of the flowchart includes associating each of the one or more cost components with a respective cost model pattern. As previously mentioned, each of the cost model patterns includes a set of formulae for computing a cost of the respective cost component in preferred approaches. Moreover, sub-operation 462 includes applying a detailed definition of each of the one or more cost components to the respective cost model pattern. Typically, this involves specifying every leaf nodes of cost component hierarchy of an offering definition. Detail configuration also include the specification of service rates depending on the type of service element. Furthermore, sub-operation 464 includes using the set of formulae in each cost model pattern to compute a specific cost corresponding to the respective cost component.

An offering definition may consist of set cost components corresponding to the services bundled. Moreover, a consistent way of specifying how to compute and customize the cost of each service element based on offering and service characteristics such as type, delivery phase and location, scaling factors and associated cost drivers. To accomplish this, some of the approaches included herein provide a unified framework which captures the general concept of how the cost should be computed and customized for each cost component of an offering using a cost model pattern. Each cost model pattern defines the characteristics of cost computation for the cost component that it is mapped to using a set of formulae.

FIG. 4I illustrates the overall outline structure for a cost model pattern in accordance with an in-use example, which is in no way intended to limit the invention. As shown, each pattern identified by a unique ID has three major sections: a component section, a baseline section, and a parameter section. The component section of the cost model pattern refers to the output portion of the cost model pattern and includes a set of formulae for computing the costs for a service element under different conditions. Furthermore, the baseline section includes internal baselines and/or external baselines of the respective cost model pattern. A baseline refers to the number of units (e.g., quantities) of a service element in an offering. Thus, internal baselines are specific to a given cost model pattern and facilitate pattern specific factors stated in the formulae. However, external baselines of a cost model pattern are mapped to the associated cost drivers of the component mapped with the given cost model pattern. Moreover, these baselines are referred to in the component formulae of the cost model pattern in many approaches.

In FIG. 4J, a set of baselines are specified for an exemplary cost model pattern, which is again in no way intended to limit the invention. As shown, external baselines have been identified with “id”: “b0”, and “id”: “b1”, while internal baselines have been identified with “id”: “t” using the flags “IsInternal: false” and “IsInternal: true” respectively. The external baselines are further mapped with the associated cost drivers of the cost component mapped. Thus, the baseline with “id”: “b0” would map to a cost driver, which is an intermediate node in cost driver hierarchy. However, the baseline with “id”: “b1” would relate to a cost driver which is a leaf node in a cost driver hierarchy.

The parameter section of a cost model pattern includes place holders that represent information involved with customizing the cost computation specified in the given cost model pattern. In FIG. 4K, a cost model pattern which defines a set of parameters to assist in customizing the cost formulae for components is illustrated in accordance with an in-use example. Moreover, it should be noted that the formulae shown in the component section of a cost model pattern in FIG. 4L, has reference to the parameters shown in the parameter section of the cost model pattern in FIG. 4K, e.g., as would be appreciated by one skilled in the art after reading the present description.

FIG. 4K also depicts the component section of a given cost model pattern. Some of the key characteristics defined in the component section include: type, phase, scale, delivery location, and formulae. The general structure of a formula that represents a cost component according to one example is represented below in Equation 1, which is in no way intended to limit the invention.

(component)={(baseline 1)+(baseline 2)+ . . . }*(rate)*(scaling factor) Equation 1

The terms “baseline 1”, “baseline 2”, etc. refers to the quantities of the cost drivers that are associated with a cost component for which the formula is applied to. Also, “rate” refers to the actual dollar value for the aforementioned quantities for the cost drivers. The rate value of a cost driver may depend on several factors such as where (e.g., country, region, city, etc.) the underlying service is delivered from and/or delivered to, exchange rates, tax and/or local law applied, etc. For instance, labor rates should be applied to a labor component in order to compute cost of the component, yet the labor rates would depend on the where the labor is delivered from, e.g., such as the country. Further still, the notion of “scaling factor” is intended to represent economies of scale. Accordingly, the general structure shows how the cost of a component is computed based on its characteristics.

In preferred approaches, global formula and local formula make up the two types of formulae which are specified in a given pattern. Moreover, the cost computation formula in a cost model pattern preferably reflects that each cost component in an offering definition specifies its own delivery location (either local to the client, or from other countries).

The formulae in the component section of a cost model pattern also has place holders for baselines and/or parameters in some approaches. These baselines and/or parameters may be specified separately in the pattern structure, e.g., as shown in FIGS. 4J and 4K. The “baseline” placeholder in the formulae of a pattern component refers to the sum of the set of associated cost drivers for the cost component mapped with the pattern. For instance, the cost component shown in FIG. 4F above has only one cost driver associated with it, which would replace “baseline” placeholder in the formulae of the mapped pattern shown in FIG. 4L.

It follows that these approaches are able to map a cost model pattern for each of the leaf node cost components, e.g., such as those shown in FIG. 4E, and generates a cost model output structure. FIG. 4M illustrates a portion of cost model output structure generated for an in-use example. As shown, the component section in the output contains the cost computation specification, including the path where the component should appear if the cost model is organized in a hierarchical manner and the formula for the cost computation. The formulae section contains the references to baselines output structures. The baseline sections in the output refers to rollout section, which contains what the monthly value should be during the period the corresponding service is provided as part of the solution.

Referring back once again to the method 400 of FIG. 4A, the one or more cost model output structures derived from different service offerings in operation 406 may be combined with and/or to form a single cost model which provides an integrated solution applicable to a vast number of service offerings. Thus, from operation 406 the flowchart proceeds to operation 408 which includes merging the one or more cost model output structures with an existing single cost model. Furthermore, operation 410 includes updating the single cost model. Again, the single cost model provides an integrated solution which can be applied to virtually any received offering, and thereby provides a consistent way to specify different offering definitions and thus results in a more efficient preparation of solutions to potential customers' offering requests, even in complex IT service environments. To further support this functionality, a service taxonomy may also be implemented.

Although a single cost model desirably provides consistency and efficiency in responding to offering requests, it should be noted that operations 408 and/or 410 are in no way required. Thus, in some approaches the one or more cost model output structures derived in operation 406 may simply be used to respond to the information originally received in operation 402. In other words, the one or more cost model output structures may be returned to a potential customer from which the information was received in operation 402, thereby providing a potential offering with pricing information, services and/or products offered, etc. The potential customer may thereby be able to decide as to whether the potential offering is to their liking and reply by accepting, denying, countering, etc.

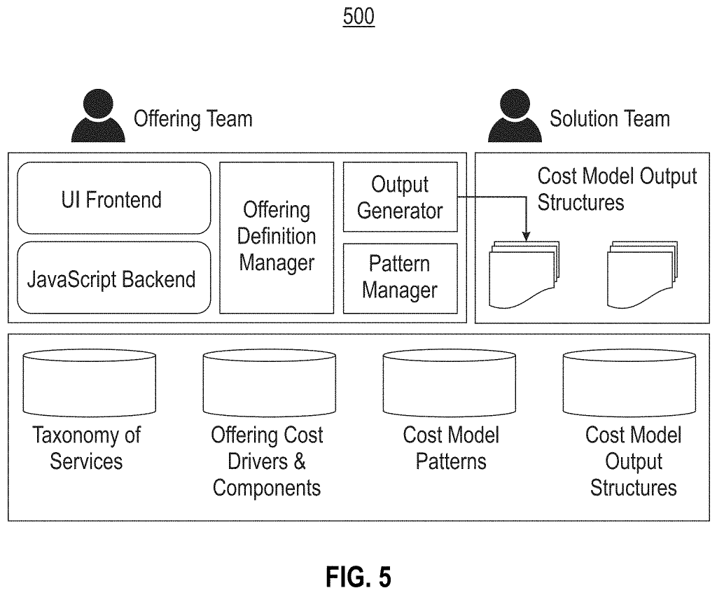

FIG. 5 illustrates the overall architectural view 500 of various components, in accordance with one embodiment. As an option, the present architecture 500 may be implemented in conjunction with features from any other embodiment listed herein, such as those described with reference to the other FIGS., such as FIGS. 4A-4M. For instance, one or more of the modules illustrated in the architecture 500 may be of conventional types, but are capable of being modified in a manner to perform any one or more of the processes of the cost model specification and/or generation described herein, e.g., as would be appreciated by one skilled in the art after reading the present description.

However, such architecture 500 and others presented herein may be used in various applications and/or in permutations which may or may not be specifically described in the illustrative embodiments listed herein. Further, the architecture 500 presented herein may be used in any desired environment. Thus FIG. 5 (and the other FIGS.) may be deemed to include any possible permutation.

According to some approaches, a single offering definition for which a set of cost components are hierarchically organized, each of the leaf cost component is mapped to a suitable pattern that describes the cost computation for the component. In the cost component hierarchy of an offering definition, the leaf nodes are retrieved. For each leaf cost component retrieved, a pattern is selected by matching the: type, phase, scale factor, global or local, number of cost parameters involved, etc.

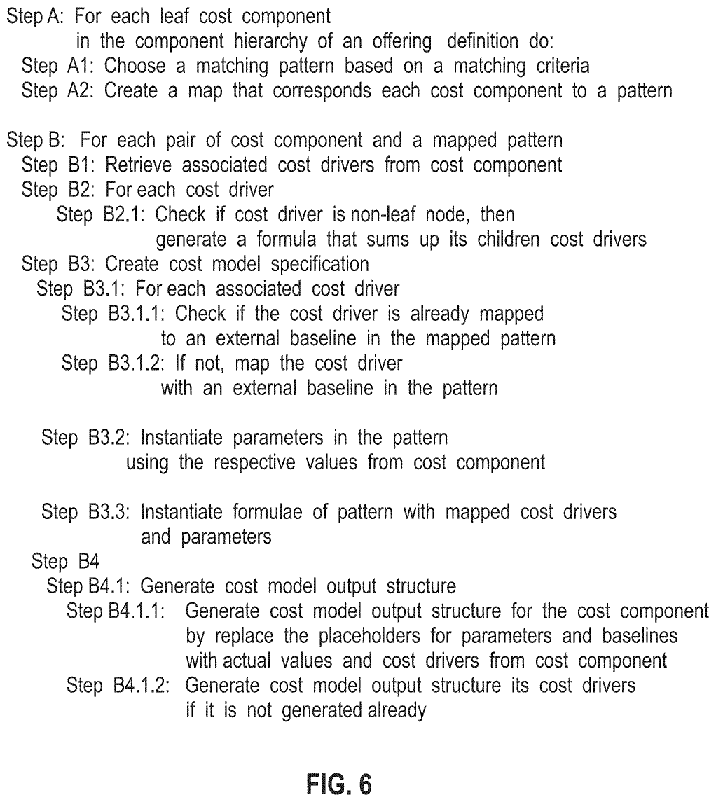

For instance, looking to FIG. 6, the cost model output structure generation process is illustrated as a sequence of steps in accordance with an in-use example which is in no way intended to limit the invention. For each leaf cost component of offering definition is preferably mapped against a cost model pattern, and the corresponding formulae for computing the cost would thereby be associated. In addition, parameter values from cost component specifications would customize the formulae. The sequence of steps shown in FIG. 6 would thereby generate a complete output structure of a cost model for an offering definition, including instantiated baselines, components, service rates, rollout, etc. Again, an example of such an output is shown above in FIG. 4M.

It follows that various ones of the embodiments included herein are able to use concepts such as cost drivers and cost components to build a cost model specification for a given offering. Then, to generate a cost model structure for the offering, a cost model pattern is associated with each cost component. An associated pattern for a cost component would contain a set of formulae for computing the cost. Using the detail definition of a cost component including its associated cost drivers, a formula for a pattern would yield the specific cost computation for the cost component of an offering definition. Furthermore, for each offering definition, the approaches herein are able to produce a cost model structure with the details that specify how cost should be computed for each of the cost component in the offering definition.

As a result, some of the embodiments herein present a unified framework that includes several constructs for specifying offering definitions for service offerings, e.g., such as service offerings in IT service environments. Moreover, performance is further improved by applying cost model patterns which include a set of formulae that can have an abstraction of cost computation and can thus be reused for different offerings. In other words, these unified frameworks allow for a consistent approach in specifying cost models for different service offerings while also maintaining the flexibility to handle any individual differences among them.

Moreover, the unified frameworks are able to generate cost model structures for the service offerings in a coherent and efficient manner. Accordingly, offerings may consistently be defined, thereby introducing the possibility of generating cost models that could be combined into a single cost model which is able to compute an integrated solution of an entire deal.

It should also be noted that although various ones of the embodiments included herein have been described in the context of IT related service offerings, any one or more of these embodiments are applicable for any type of service offering.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
receiving information which corresponds to an offering;
generating an offering definition by defining basic properties of the offering, wherein defining the basic properties of the offering includes:
defining one or more cost drivers which correspond to the offering, and
defining one or more cost components which correspond to the offering;
using the basic properties of the offering to generate one or more cost model output structures;
merging the one or more cost model output structures with a single cost model; and
updating the single cost model.

2. The computer-implemented method of claim 1, wherein defining one or more cost drivers which correspond to the offering includes:
defining a cost drive hierarchy; and
defining a cost driver specification.

3. The computer-implemented method of claim 1, wherein defining one or more cost components which correspond to the offering includes:
constructing a cost component hierarchy; and
constructing a cost component specification.

4. The computer-implemented method of claim 1, wherein using the basic properties of the offering to generate a cost model structure for the offering definition includes:
associating each of the one or more cost components with a respective cost model pattern, wherein each of the cost model patterns includes a set of formulae for computing a cost of the respective cost component;
applying a definition of each of the one or more cost components to the respective cost model pattern; and
using the set of formulae in each cost model pattern to compute a cost corresponding to the respective cost component.

5. The computer-implemented method of claim 4, wherein each of the cost model patterns includes: a component section, a baseline section, and a parameters section.

6. The computer-implemented method of claim 5, wherein the baseline section further includes internal baselines and/or external baselines of the respective cost model pattern.

7. The computer-implemented method of claim 1, wherein the offering includes one or more desired services and/or products.

8. A computer program product comprising a computer readable storage medium having program instructions embodied therewith, wherein the computer readable storage medium is not a transitory signal per se, the program instructions readable and/or executable by a processor to cause the processor to perform a method comprising:
receiving, by the processor, information which corresponds to an offering;
generating, by the processor, an offering definition by defining basic properties of the offering, wherein defining the basic properties of the offering includes:
defining one or more cost drivers which correspond to the offering, and
defining one or more cost components which correspond to the offering;
using, by the processor, the basic properties of the offering to generate one or more cost model output structures;
merging, by the processor, the one or more cost model output structures with a single cost model; and
updating, by the processor, the single cost model.

9. The computer program product of claim 8, wherein defining one or more cost drivers which correspond to the offering includes:
defining a cost drive hierarchy; and
defining a cost driver specification.

10. The computer program product of claim 8, wherein defining one or more cost components which correspond to the offering includes:
constructing a cost component hierarchy; and
constructing a cost component specification.

11. The computer program product of claim 8, wherein using the basic properties of the offering to generate a cost model structure for the offering definition includes:
associating each of the one or more cost components with a respective cost model pattern, wherein each of the cost model patterns includes a set of formulae for computing a cost of the respective cost component;
applying a definition of each of the one or more cost components to the respective cost model pattern; and
using the set of formulae in each cost model pattern to compute a cost corresponding to the respective cost component.

12. The computer program product of claim 11, wherein each of the cost model patterns includes: a component section, a baseline section, and a parameters section.

13. The computer program product of claim 12, wherein the baseline section further includes internal baselines and/or external baselines of the respective cost model pattern.

14. The computer program product of claim 8, wherein the offering includes one or more desired services and/or products.

15. A system, comprising:
a processor; and
logic integrated with the processor, executable by the processor, or integrated with and executable by the processor, the logic being configured to:
receive, by the processor, information which corresponds to an offering;
generate, by the processor, an offering definition by defining basic properties of the offering, wherein defining the basic properties of the offering includes:
defining one or more cost drivers which correspond to the offering, and
defining one or more cost components which correspond to the offering;
use, by the processor, the basic properties of the offering to generate one or more cost model output structures;
merge, by the processor, the one or more cost model output structures with a single cost model; and
update, by the processor, the single cost model.

16. The system of claim 15, wherein defining one or more cost drivers which correspond to the offering includes: defining a cost drive hierarchy; and defining a cost driver specification, wherein defining one or more cost components which correspond to the offering includes: constructing a cost component hierarchy; and
constructing a cost component specification.

17. The system of claim 15, the logic being configured to:
merge, by the processor, the one or more cost model output structures with a single cost model; and
update, by the processor, the single cost model.

18. The system of claim 15, wherein using the basic properties of the offering to generate a cost model structure for the offering definition includes:
associating each of the one or more cost components with a respective cost model pattern, wherein each of the cost model patterns includes a set of formulae for computing a cost of the respective cost component;
applying a definition of each of the one or more cost components to the respective cost model pattern; and
using the set of formulae in each cost model pattern to compute a cost corresponding to the respective cost component.

19. The system of claim 18, wherein each of the cost model patterns includes: a component section, a baseline section, and a parameters section, wherein the baseline section further includes internal baselines and/or external baselines of the respective cost model pattern.

20. The system of claim 15, wherein the offering includes one or more desired services and/or products.
